(19) United States
(12) Patent Application Publication
(10) Pub. No.: US 2025/0387997 A1
(43) Pub. Date: Dec. 25, 2025

(54) TEXTILE FABRIC

(71) Applicant: JHIH HUEI TRADING CO., LTD., CHANGHUA COUNTY (TW)

(72) Inventor: YUNG-YU WU, Changhua County (TW)

(21) Appl. No.: 18/753,132

(22) Filed: Jun. 25, 2024

(51) Int. Cl. B32B 5/02; B32B 3/28; B32B 3/30; B32B 27/12; B32B 27/30; B32B 27/40

(52) U.S. Cl. CPC B32B 5/026; B32B 3/28; B32B 3/30; B32B 27/12; B32B 27/304; B32B 27/40; B32B 2262/16; B32B 2307/724; B32B 2307/7265; B32B 2307/7375; B32B 2307/7376

(57) ABSTRACT

A textile fabric is provided, including: a main body and at least one film layer. The main body includes two surfaces opposite to each other, and each of the two surfaces has a surface texture being concave and convex. The at least one film layer is coveringly disposed on at least one of the two surfaces, and each said film layer is concave and convex corresponding to the surface texture. Therefore, the at least one film layer has an appearance corresponding to the surface texture, and the textile fabric has good toughness, is waterproof and is not easily damaged, which solves the problems of insufficient structural strength and poor durability of a conventional textile fabric.

### BACKGROUND OF THE INVENTION

### Field of the Invention

The present invention relates to a textile fabric.

### Description of the Prior Art

Textile fabrics are made by a plurality of yarns through different techniques such as knitting and weaving, and they are widely used in daily life including clothing, shoe uppers, bags, etc. To achieve waterproof and toughening effects, surfaces of the textile fabrics may be coated with a waterproof coating, or the plurality of yarns may be covered with a waterproof coating before weaving.

However, the meshes of the textile fabric may be covered by the waterproof coating on the surfaces, which results in poor softness and poor appearance of the textile fabric, and easy peeling of the waterproof coating. The plurality of yarns with the waterproof coating may have poor flexibility and high frictional resistance, which is inconvenient to weaving and provides poor tactile feel of the textile fabric. In addition, when the meshes of the textile fabrics are large, the textile fabric made by the plurality of yarns with the waterproof coating still cannot achieve waterproof effect.

The present invention is, therefore, arisen to obviate or at least mitigate the above-mentioned disadvantages.

### SUMMARY OF THE INVENTION

The main object of the present invention is to provide a textile fabric, which is waterproof and has good flexibility and appearance.

To achieve the above and other objects, the present invention provides a textile fabric, including: a main body and at least one film layer. The main body includes two surfaces opposite to each other, and each of the two surfaces has a surface texture being concave and convex. The at least one film layer is coveringly disposed on at least one of the two surfaces, and each of the at least one film layer is concave and convex corresponding to the surface texture.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention; and

FIG. 2 is a partial cross-sectional view of a preferable embodiment of the present invention.

### DETAILED DESCRIPTION OF THE PREFERRED EMBODIMENTS

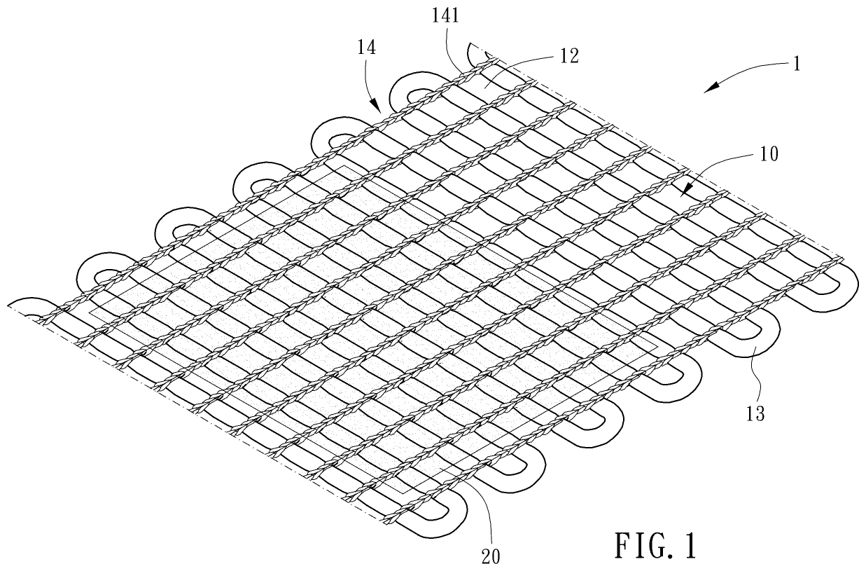

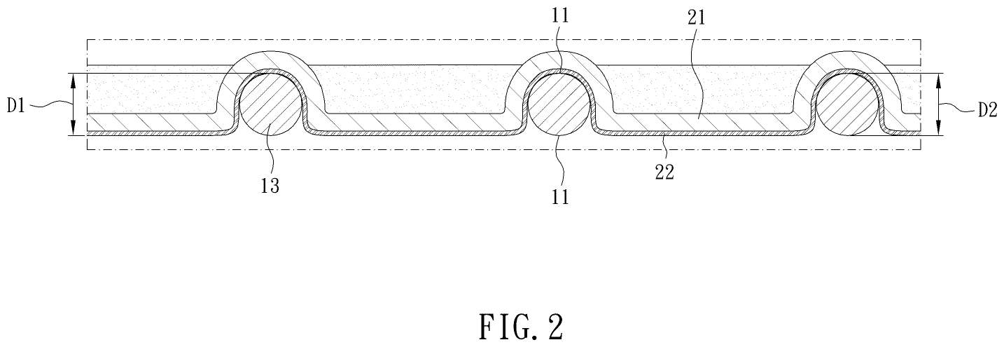

Please refer to FIGS. 1 to 2 for a preferable embodiment of the present invention. A textile fabric 1 of the present invention includes a main body 10 and at least one film layer 20.

The main body 10 includes two surfaces 11 opposite to each other, and each of the two surfaces 11 has a surface texture being concave and convex. The at least one film layer 20 is coveringly disposed on at least one of the two surfaces 11, and each of the at least one film layer 20 is concave and convex corresponding to the surface texture. Therefore, the at least one film layer 20 have an appearance corresponding to the surface texture of the main body 10, and the textile fabric 1 has good toughness and is waterproof and not easy to be damaged.

The at least one film layer 20 is made of a material including at least one of polyurethane and polyvinyl chloride, and a thickness of each of the at least one film layer 20 is between 20 μm and 450 μm. Therefore, the at least one film layer 20 can increase structural strength of the textile fabric 1, and the appropriate thickness of the at least one film layer 20 avoids reducing the flexibility of the textile fabric 1 so as to provide good adhesion and be not easy to peel off. In this embodiment, the at least one film layer 20 is made of a material including polyurethane and is a waterproof breathable film layer so as to advantages of wear-resistant, good toughness, environmentally friendly and decomposable. The thickness of each of the at least one film layer 20 is between 50 μm and 400 μm. The at least one film layer 20 is partially covered on one of the two surfaces 11, and the at least one film layer 20 accounts for no more than 40% of a weight of the textile fabric 1 so as to avoid excessively increasing the weight of the textile fabric 1. However, the at least one film layer may be completely covered on one of the two surfaces, and an area that the at least one film layer covering one of the two surfaces is changeable.

Preferably, each of the at least one film layer 20 includes a film material layer 21 and a connecting layer 22, and the connecting layer 22 is disposed on a side of the film material layer 21 and connected with one of the two the surfaces 11. A thickness of the connecting layer 22 is smaller than or equal to a thickness of the film material layer 21, which facilitates connection between the at least one film layer 20 and the main body 10. A material of the connecting layer 22 is preferably different from a material to the film material layer 21, for example, the film material layer 21 may be made of thermoplastic polyurethane, and the connecting layer 22 may be made of a material that has preferable bonding strength with the main body 10 for stable connection. The film material layer 21 is preferably integrated with the connecting layer 22 in advance. For example, the connecting layer 22 may be partially or completely pre-coated, spayed or filmed on a side of the film material layer 21 so that the at least one film layer 20 is convenient to be used during processing.

The main body 10 further includes a plurality of holes 12, and the at least one film layer 20 is recessed within the plurality of holes 12 so as to provide an appearance corresponding to the surface texture. Preferably, the plurality of holes 12 at least partially penetrate through the two surfaces 11, and the at least one film layer 20 is coveringly disposed on one of the two surfaces 11 and exposed outwardly from the other of the two surfaces 11, which can stably restrict the main body 10 and increase a tensile strength of the main body 10. A color of the at least one film layer 20 may be different from a color of the main body 10, and the at least one film layer 20 may be transparent or semi-transparent, which is selectable to generate different visual effects. A diametrical dimension of each of the plurality of holes 12 is larger than or equal to 0.5 mm (preferably larger than or equal to 1 mm), a depth of the at least one film layer 20 recessed within one of the plurality of holes 12 is larger than or equal to ⅓ (preferably larger than or equal to ½) of a depth D2 of said hole holes 12. A portion of the at least one film layer 20 recessed within the plurality of holes 12 is substantially flush with one of the two surfaces 11, which provides an obvious concave-convex visual effect and effectively positions the plurality of holes 12. In this embodiment, each of the plurality of holes 12 is rectangular. The main body 10 further includes a plurality of yarns 13, and said surface textures of the two surfaces 11 are formed by interlacing the plurality of yarns 13. As viewed in a cross-sectional direction of one of the plurality of yarns 13, the at least one film layer 20 covers at least ½ of an outer circumferential surface of said yarns 13, as shown in FIG. 2, which can prevent the plurality of yarns 13 from becoming unraveled when being cut to facilitate easy processing. Preferably, at least two of the plurality of yarns 13 have diameters different from one another so that said surface textures of the two surfaces 11 of the main body 10 have obvious concave and convex three-dimensional structures, and the at least one film layer 20 disposed thereon also has obvious concave and convex appearance.

The main body 10 further includes a knitted structure 14, and each of the at least one knitted structure 14 includes a plurality of loops 141 sleeved to one another. With the at least one film layer 20, the problem that existing knitted fabrics are easily decomposed when cut can be solved, and the textile fabric 1 of the present invention has a stable structure and is convenient to use. Moreover, the sleeving structures of the plurality of loops 141 also provide obvious concave and convex three-dimensional structures, and the at least one film layer 20 disposed thereon has obvious concave and convex appearance.

In other embodiments, the plurality of yarns may be intertwined diagonally to form the main body and define the plurality of holes; the main body may be made by weaving, knitting, braiding or any other ways; both of the two surfaces may be covered partially or completely by the at least one film layer.

During manufacturing, the main body 10 and the at least one film layer 20 are stacked on a platform with a plurality of suction holes in sequence, and then air is extracted through the plurality of suction holes and a hot plate is pressed on a side of the at least one film layer 20 opposite to the main body 10. As a result, the at least one film layer 20 is soften by heat and attached to the plurality of yarns 13 and recessed within the plurality of holes 12, providing an appearance convex and concave corresponding to the surface texture of one of the two surfaces 11.

In summary, the at least one film layer of the present invention covers the plurality of holes to achieve waterproof, breathable and anti-slip effects, and the plurality of yarns are held in place by the at least one film layer so that the textile fabric has excellent tensile strength and maintains good flexibility. In addition, the color of the at least one film layer is changeable to provide various appearances, and the at least one film layer is concave and convex corresponding to the surface texture of at least one of the two surface of the main body, providing special visual effect.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A textile fabric, including:
a main body, including two surfaces opposite to each other, each of the two surfaces having a surface texture being concave and convex; and
at least one film layer, coveringly disposed on at least one of the two surfaces, each of the at least one film layer being concave and convex corresponding to the surface texture.

2. The textile fabric of claim 1, wherein the main body further includes at least one knitted structure, and each of the at least one knitted structure includes a plurality of loops sleeved to one another.

3. The textile fabric of claim 1, wherein the main body further includes a plurality of yarns, as viewed in a cross-sectional direction of one of the plurality of yarns, the at least one film layer covers at least ½ of an outer circumferential surface of said yarn.

4. The textile fabric of claim 1, wherein the at least one film layer is made of a material including at least one of polyurethane and polyvinyl chloride.

5. The textile fabric of claim 1, wherein each of the at least one film layer includes a film material layer and a connecting layer, the connecting layer is disposed on a side of the film material layer and connected with one of the two surfaces, and a thickness of the connecting layer is smaller than or equal to a thickness of the film material layer.

6. The textile fabric of claim 1, wherein a thickness of each of the at least one film layer is between 20 μm and 450 μm.

7. The textile fabric of claim 1, wherein the main body further includes a plurality of holes recessed thereon, and the at least one film layer is recessed within the plurality of holes.

8. The textile fabric of claim 7, wherein the plurality of holes at least partially penetrate through the two surfaces, and the at least one film layer is coveringly disposed on one of the two surfaces and exposed outwardly from the other of the two surfaces.

9. The textile fabric of claim 7, wherein a diametrical dimension of each of the plurality of holes is larger than or equal to 0.5 mm, and a depth of the at least one film layer recessed within one of the plurality of holes is larger than or equal to ⅓ of a depth of said hole.

10. The textile fabric of claim 5, wherein the main body further includes at least one knitted structure, and each of the at least one knitted structure includes a plurality of loops sleeved to one another; the main body further includes a plurality of yarns, as viewed in a cross-sectional direction of one of the plurality of yarns, the at least one film layer covers at least ½ of an outer circumferential surface of said yarn; at least two of the plurality of yarns have diameters different from one another; the at least one film layer is made of a material including polyurethane and is a waterproof breathable film layer; a material of the connecting layer is different from a material of the film material layer; a thickness of each of the at least one film layer is between 50 μm and 400 μm; the main body further includes a plurality of holes recessed thereon, and the at least one film layer is recessed within the plurality of holes; the plurality of holes at least partially penetrate through the two surfaces, and the at least one film layer is coveringly disposed on one of the two surfaces and exposed outwardly from the other of the two surfaces; a diametrical dimension of each of the plurality of holes is larger than or equal to 1 mm, and a depth of the at least one film layer recessed within one of the plurality of holes is larger than or equal to ½ of a depth of said hole; a portion of the at least one film layer recessed within the plurality of holes is substantially flush with one of the two surfaces; each of the plurality of holes is rectangular; and the at least one film layer is partially covered on one of the two surfaces, and a weight of the at least one film layer accounts for no more than 40% of a weight of the textile fabric.
